(19) United States
(12) Patent Application Publication
(10) Pub. No.: US 2018/0063299 A1
(43) Pub. Date: Mar. 1, 2018

(54) TRANSITION INTERVALS FOR CHANNEL BONDING IN WIRELESS NETWORKS

(71) Applicant: Intel IP Corporation, Santa Clara, CA (US)

(72) Inventors: Michael Genossar, Modi'in (IL); Yanai Mozes, Haifa (IL); Artyom Lomayev, Nizhny Novgorod (RU); Yaroslav P. Gagiev, Nizhny Novgorod (RU); Alexander Maltsev, Nizhny Novgorod (RU); Carlos Cordeiro, Portland, OR (US)

(21) Appl. No.: 15/474,836

(22) Filed: Mar. 30, 2017

Related U.S. Application Data
(60) Provisional application No. 62/380,939, filed on Aug. 29, 2016.

(51) Int. Cl. H04L 29/08; H04L 12/28

(52) U.S. Cl. CPC H04L 69/323; H04W 84/12; H04L 12/2863

(57) ABSTRACT

This disclosure describes enhanced directional multi gigabit (EDMG) physical layer convergence procedure (PLCP) protocol data unit (PPDU) frames and frame formats for wireless networks. The frame can include a legacy portion and a non-legacy portion. The legacy portion of the frame can be transmitted using a legacy sample (or chip) rate. The non-legacy portion of the frame can be transmitted using a second, different sample (or chip) rate. A transition interval field may be defined between the legacy and the non-legacy portions of the frame, the transition interval field having a predetermined time duration. In one embodiment, the transition interval field can be defined and/or used in connection with one or more standards (for example, a IEEE 802.11ay standard). The various embodiments disclosed herein can be used to facilitate hardware implementation, increase vendor-agnostic compatibility, and allow for accurate, vendor agnostic time-of-flight (ToF) measurements.

### CROSS REFERENCE TO RELATED APPLICATIONS

This application claims the benefit of U.S. Provisional Patent Application No. 62/380,939, filed on Aug. 29, 2016, the disclosure of which is incorporated herein by reference in its entirety.

### TECHNICAL FIELD

This disclosure generally relates to systems and methods for wireless communications and, more particularly, systems and methods to channel bonding for wireless communication.

### BACKGROUND

Various standards, for example, Institute of Electrical and Electronics Engineers (IEEE) 802.11ay, are being developed for the millimeter (mm) wave (for example, 60 GHz) frequency band of the spectrum. For example, IEEE 802.11ay is one such standard. IEEE 802.11ay is related to the IEEE 802.11ad standard, also known as WiGig. IEEE 802.11ay seeks, in part, to increase the transmission data rate between two or more devices in a network, for example, by implementing Multiple Input Multiple Output (MIMO) techniques.

### BRIEF DESCRIPTION OF THE DRAWINGS

FIG. 1 shows an exemplary network environment, in accordance with the systems and methods disclosed herein.

FIG. 2 shows a diagram of an example general frame format for Enhanced Directional Multi Gigabit (EDMG) Physical Layer Convergence Procedure (PLCP) Protocol Data Unit (PPDU), in accordance with example embodiments of the disclosure.

FIGS. 3A, 3B, and 3C show diagrams of example definitions of the transition interval for different channel bonding factors in the case of single stream transmission, in accordance with example embodiments of the disclosure.

FIGS. 4A, 4B, and 4C show diagrams of example definitions of the transition interval for a channel bonding factor of 2 for multiple stream transmission, in accordance with example embodiments of the disclosure.

FIG. 5 show a diagram of an example flow chart for an example operation of the disclosed systems, methods, and apparatus, in accordance with one or more example embodiments of the disclosure.

FIG. 6 show another diagram of an example flow chart for an example operation of the disclosed systems, in accordance with one or more example embodiments of the disclosure.

FIG. 7 illustrates a functional diagram of an example communication station that may be suitable for use as a user device, in accordance with one or more example embodiments of the disclosure.

FIG. 8 shows a block diagram of an example machine upon which any of one or more techniques (e.g., methods) may be performed, in accordance with one or more embodiments of the disclosure.

### DETAILED DESCRIPTION

Example embodiments described herein provide certain systems, methods, and devices, for providing signaling information to Wi-Fi devices in various Wi-Fi networks, in accordance with IEEE 802.11 communication standards, including but not limited to IEEE 802.11ay.

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

In various embodiments, the disclosure describes enhanced directional multi gigabit (EDMG) physical layer convergence procedure (PLCP) protocol data unit (PPDU) frames and frame formats for wireless networks. In one embodiment, the frame can include a legacy portion and a non-legacy portion. In one embodiment, the legacy portion of the frame can be transmitted using a legacy sample (or chip) rate. In one embodiment, the non-legacy portion of the frame can be transmitted using a second, different sample (or chip) rate. In one embodiment, a transition interval field may be defined between the legacy and the non-legacy portions of the frame, the transition interval field having a predetermined time duration. In one embodiment, the transition interval field can be defined and/or used in connection with one or more standards (for example, a IEEE 802.11ay standard). The various embodiments disclosed herein can be used to facilitate hardware implementation, increase vendor-agnostic compatibility, and allow for accurate, vendor agnostic time-of-flight (ToF) measurements.

In various embodiments, the legacy portion of the frame can include a legacy preamble, a legacy header, a EDMG-Header-A containing single user (SU) multiple-input and multiple-output (MIMO) parameters. In another embodiment, the non-legacy portion of the frame can include an EDMG short training field (EDMG-STF), an EDMG channel estimation field (EDMG-CEF), an EDMG-Header-B containing MU-MIMO parameters, a payload data portion, an optional automatic gain control (AGC), and one or more beamforming training units appended at the end of the frame.

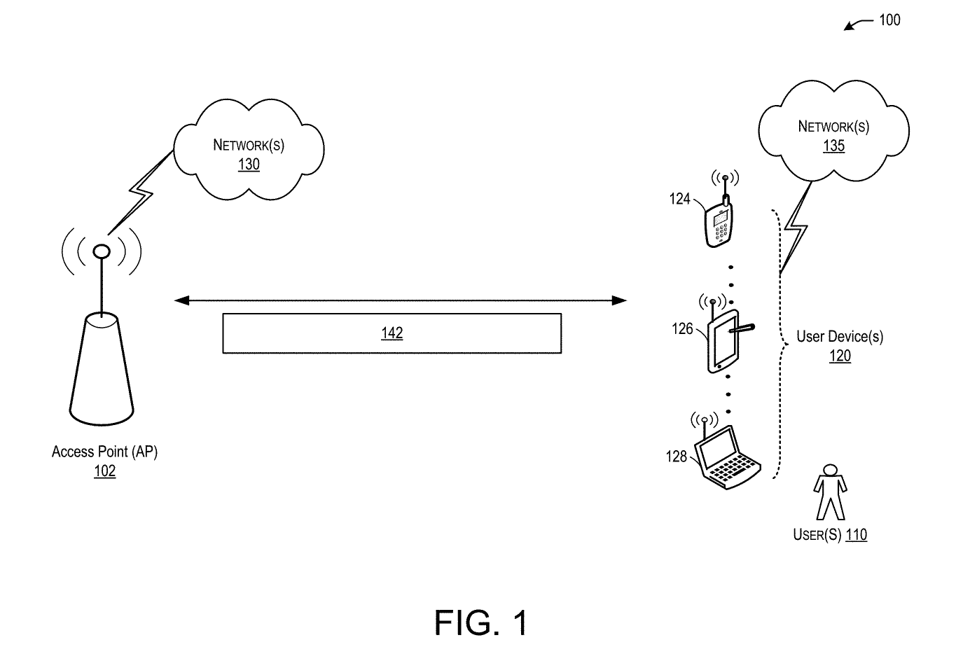

FIG. 1 is a network diagram illustrating an example network environment, according to some example embodiments of the present disclosure. Wireless network 100 may include one or more devices 120 and one or more access point(s) (AP) 102, which may communicate in accordance with IEEE 802.11 communication standards, including IEEE 802.11ay. The device(s) 120 may be mobile devices that are non-stationary and do not have fixed locations.

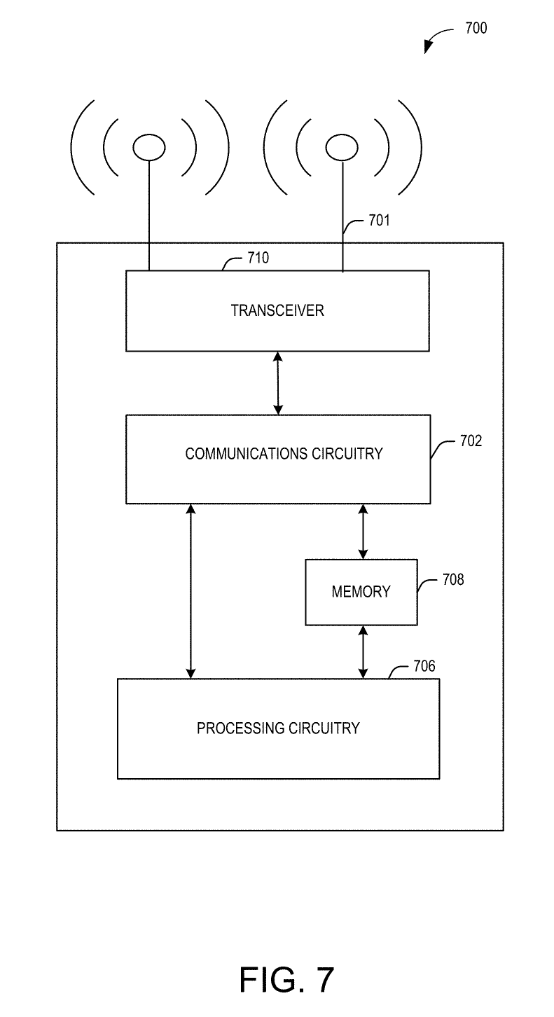

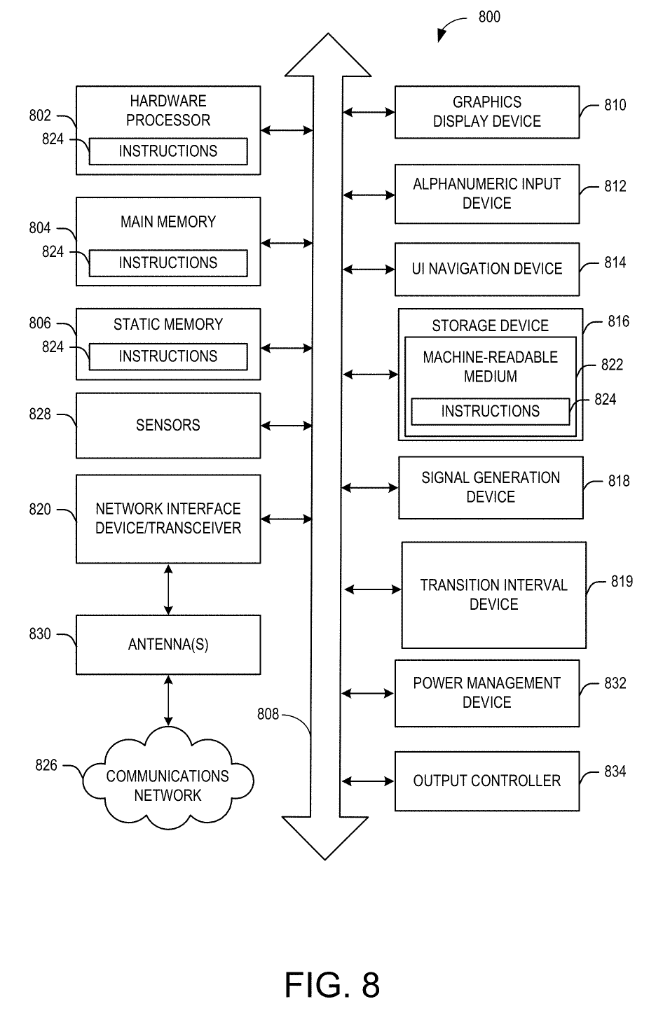

The user device(s) 120 (e.g., 124, 126, or 128) may include any suitable processor-driven user device including, but not limited to, a desktop user device, a laptop user device, a server, a router, a switch, an access point, a smartphone, a tablet, wearable wireless device (e.g., bracelet, watch, glasses, ring, etc.) and so forth. In some embodiments, the user devices 120 and AP 102 may include one or more computer systems similar to that of the functional diagram of FIG. 7 and/or the example machine/system of FIG. 8, to be discussed further.

Returning to FIG. 1, any of the user device(s) 120 (e.g., user devices 124, 126, 128), and AP 102 may be configured to communicate with each other via one or more communications networks 130 and/or 135 wirelessly or wired. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128), and AP 102 may include one or more communications antennae. Communications antenna may be any suitable type of antenna corresponding to the communications protocols used by the user device(s) 120 (e.g., user devices 124, 124 and 128), and AP 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, or the like. The communications antenna may be communicatively coupled to a radio component to transmit and/or receive signals, such as communications signals to and/or from the user devices 120.

Any of the user devices 120 (e.g., user devices 124, 126, 128), and AP 102 may include any suitable radio and/or transceiver for transmitting and/or receiving radio frequency (RF) signals in the bandwidth and/or channels corresponding to the communications protocols utilized by any of the user device(s) 120 and AP 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n), 5 GHz channels (e.g. 802.11n, 802.11ac), or 60 GHZ channels (e.g. 802.11ad). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

Typically, when an AP (e.g., AP 102) establishes communication with one or more user devices 120 (e.g., user devices 124, 126, and/or 128), the AP may communicate in the downlink direction by sending one or more data frames (e.g. 142). The data frames may be preceded by one or more preambles that may be part of one or more headers. These preambles may be used to allow the user device to detect a new incoming data frame from the AP. A preamble may be a signal used in network communications to synchronize transmission timing between two or more devices (e.g., between the APs and user devices).

As mentioned, in various embodiments, described herein is an enhanced directional multi gigabit (EDMG) physical layer convergence procedure (PLCP) Protocol Data Unit (PPDU) frames and frame formats. In various embodiments, the frame can include a legacy preamble, a legacy header, a EDMG-Header-A containing single user (SU) multiple-input and multiple-output (MIMO) parameters, an EDMG short training field (EDMG-STF), an EDMG channel estimation field (EDMG-CEF), an EDMG-Header-B containing MU-MIMO parameters, a payload data portion, an optional automatic gain control (AGC), and one or more beamforming training units appended at the end of the frame.

In one embodiment, the legacy preamble, the legacy header, and the EDMG-Header-A can be transmitted using single-input and single-output (SISO) single carrier (SC) physical layer (PHY) modulation, for example, as defined in the IEEE 802.11ad standard. In another embodiment, the legacy preamble, legacy header and the EDMG-Header-A can be transmitted using the legacy sample (or chip) rate of approximately F_{c}=1.76 GHz. In an embodiment, one or more legacy directional multi gigabit (DMG) devices can decode the legacy headers and identify (for example, using a signaling bit) that the frame contains an incompatible EDMG. The DMG devices can realize backward compatibility with EDMG devices using one or more legacy fields. In one embodiment, EDMG devices can decode the EDMG-Header-A, for example, using SISO SC PHY, and extract one or more parameters for MIMO and channel bonding frame reception. In one embodiment, the transmission of the rest of the frame may be done using either a SISO mode or a MIMO mode and using either a single channel (SC) mode or a bonded channel mode.

In one embodiment, the implementation of the channel bonding technique may involve increasing the sampling rate, for example, by a factor of N_{CB}=2, 3, or 4. The sampling rate change (from the legacy sampling rate equal to approximately Fc=1.76 GHz) to a sampling rate equal to approximately Fb=N_{CB}*1.76 GHz (N_{CB}=2, 3, 4) can be performed at the beginning of the EDMG-STF field.

Further, this disclosure describes systems and methods for the transition between DMG and EDMG devices can be used in connection with one or more standards (for example, a IEEE 802.11ay standard). The various embodiments disclosed herein can be used to facilitate hardware implementation, increase vendor-agnostic compatibility, and allow for accurate, vendor agnostic time-of-flight (ToF) measurements.

In various embodiments, this disclosure describes the transition interval between the signal taken at the legacy sample (or chip) rate equal to approximately Fc=1.76 GHz and a sample rate equal to approximately Fb=N_{CB}*1.76 GHz (N_{CB}=2, 3, 4) that may be required for channel bonding transmission. In one embodiment, the disclosure can be used in connection with highly-directional antennas, for example, one or more phase antenna arrays (PAAs).

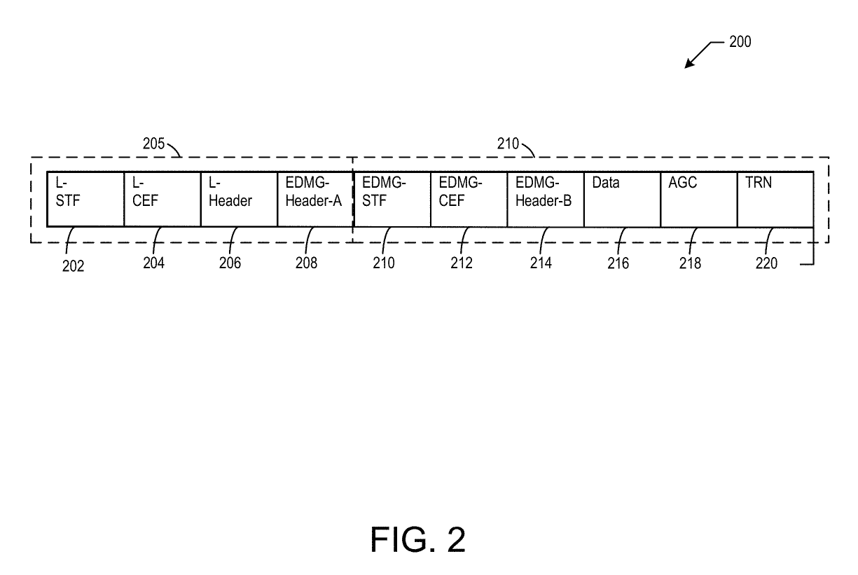

FIG. 2 shows a diagram 200 of an example general frame format for the EDMG PPDU in accordance with example embodiments of the disclosure. In one embodiment, the preamble of the PPDU can include a legacy short training field (STF) 202, a legacy channel estimation filed (CEF) 204, a legacy header L-Header field 206, an EDMG-Header-A field 208, an EDMG-STF field 210, an EDMG-CEF field 212, and an EDMG-Header-B field 214. Beside the preamble, the PPDU can further include a data portion field 216 and an optional automatic gain control (AGC) field 218 and beamforming training units (TRN) field 220.

In one embodiment, a first portion 205 of the PPDU preamble of FIG. 2 can be transmitted using SISO SC PHY modulation. In one embodiment, the first portion 205 of the PPDU preamble can include the legacy short training field (STF) 202, legacy channel estimation filed (CEF) 204, legacy header L-Header field 206, and the EDMG-Header-A field 208. In one embodiment, the first portion 205 of the PPDU preamble of FIG. 2 can be defined at the legacy sample (or chip) rate equal to approximately Fc=1.76 GHz.

In another embodiment, the second portion 210 of the PPDU of FIG. 2 of the PPDU in case of channel bonding can be defined at the sample rate equal to approximately Fb=N_{CB}*1.76 GHz (N_{CB}=2, 3, 4). In one embodiment, the second portion 210 of the PPDU can include the EDMG-STF field 210, the EDMG-CEF field 212, the EDMG-Heabex xsHeader-B field 214. Beside the preamble, the PPDU can 212, the EDMG-Header-B field 214, the data portion field 216, the optional automatic gain control (AGC) field 218, and the beamforming training units (TRN) field 220. The definition of the transition interval between the first portion 205 and the second portion 210 of the frame for channel bonding transmission is further described below.

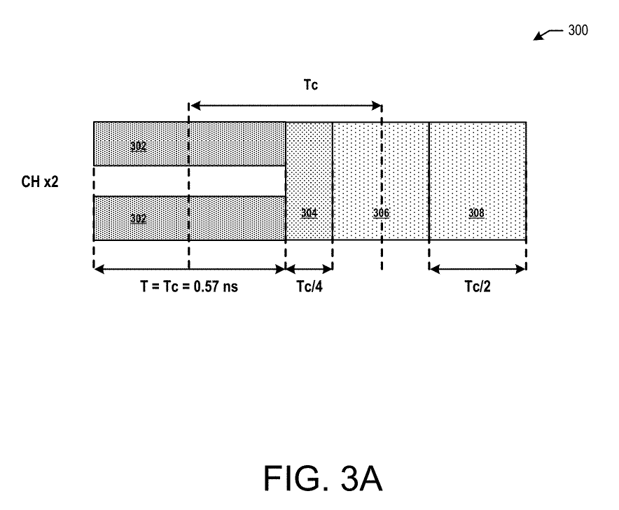

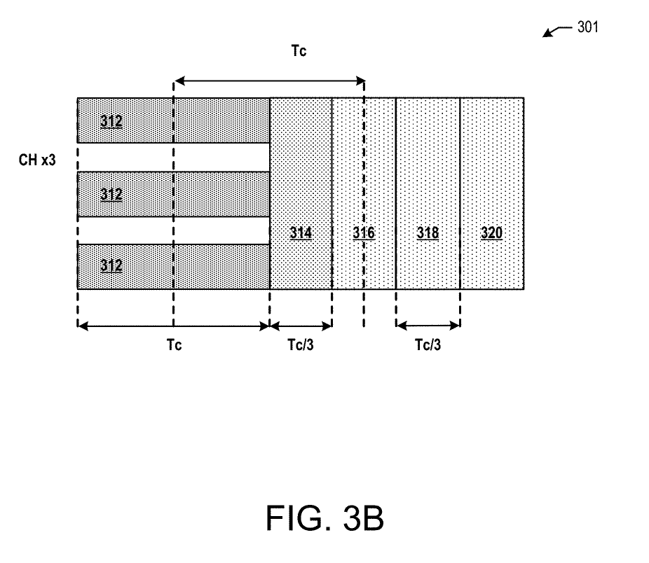

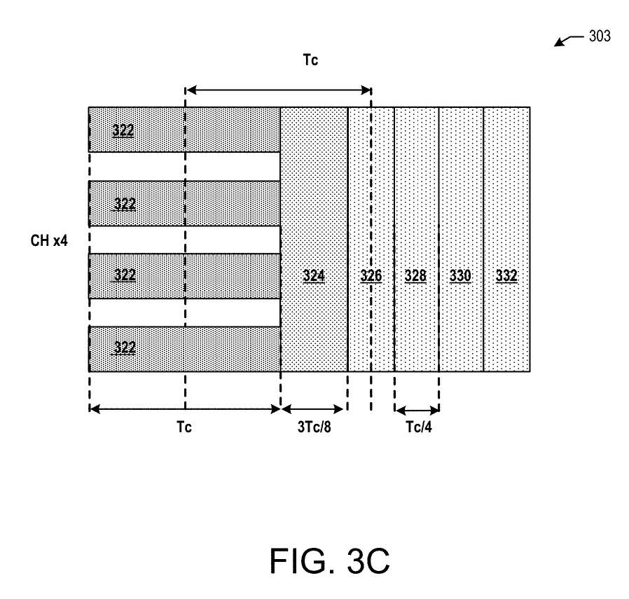

FIGS. 3A, 3B and 3C show diagrams of an example definition of the transition interval for different channel bonding factors in the case of single stream transmission in accordance with example embodiments of the disclosure. In particular, FIG. 3A show diagram of an example definition of the transition interval for a channel bonding factor of 2 in the case of single stream transmission in accordance with example embodiments of the disclosure.

In one embodiment, FIG. 3A represents a single stream transmission PPDU 300 with a channel bonding factor of 2. In one embodiment, the PPDU 300 can include legacy symbols 302 transmitted on two channels. In one embodiment, the legacy symbols 302 can be represented, for example, by one or more of the symbols of the first portion 205 of the PPDU preamble as shown and described in connection with FIG. 2.

In one embodiment, the legacy symbols 302 of the PPDU 300 can be taken at the legacy sample (or chip) rate. In one embodiment, the legacy sample (or chip) rate equal to approximately Fc=1.76 GHz, and the can have sample (or chip) duration of approximately Tc=1/Fc=0.57 ns, and where Fc represents the carrier frequency.

In another embodiment, a first sample 306 and/or a second sample 308 can be taken at a second, higher sampling rate with respect to the sample rate taken for the last symbols 302. For example, of approximately Fb=N_{CB}*1.76 GHz (N_{CB}=2, 3, 4), with a smaller sample duration Tb=Tc/N_{CB}. In one embodiment, the first sample 306 and/or the second sample 308 can be represented, for example, by any one of the symbols of the second portion 210 of the PPDU preamble as shown and described in connection with FIG. 2.

In one embodiment, the transition interval 304 can be defined between different sample rate definitions used for the different symbol types, that is, between the legacy symbols 302 and the first sample 306 and/or the second sample 308. In various embodiments, the disclosure describes defining the time interval duration between the centers of the last sample taken at the legacy rate (for example, equal to approximately Fc=1.76 GHz) and the first sample taken at a second sample rate (for example, of approximately Fb=N_{CB}*1.76 (N_{CB}=2, 3, 4), where N_{CB} is equal to the channel bonding factor). In one embodiment, the second sample rate can be equal to the chip time duration (for example, of approximately Tc=0.57 ns), which can be independent of the channel bonding factor N_{CB}.

In one embodiment the time interval 304 duration between the center of the first can be equal to multiple integral of the chip time, Tc.

In another embodiment, the duration of the transition interval can depend on the channel bonding factor and may be equal to approximately Tc/4, approximately Tc/3 and approximately 3*Tc/8 in case of N_{CB}=2, 3, and 4, accordingly.

A formula for the transition interval 304 duration can be written as:

Ttr=(Tc/2)*(1−1/N_{CB}) (eq. 1).

In one embodiment the definition of a signal comprising one or more symbols for transmission during the transition interval 304 may be not defined since the interval may be too short, e.g., below a predetermined threshold in length and/or size. In other embodiment the signal in 304 may be defined as a zero signal (which can be referred to as a “quiet” period). Alternatively or additionally, the definition of the signal comprising one or more symbols for transmission during the transition interval 304 may be defined for use, for example, in accordance with one or more standards. For example, the signal comprising one or more symbols for transmission during the transition interval 304 can include synchronization information, data, metadata, Request to Send (RTS) and/or Clear to Send (CTS) information, and the like.

FIG. 3B show diagram of an example definition of the transition interval for a channel bonding factor of 3 in the case of single stream transmission in accordance with example embodiments of the disclosure.

In one embodiment, FIG. 3B represents a single stream transmission PPDU 301 with a channel bonding factor of 3. In one embodiment, the PPDU 301 can include legacy symbols 312 transmitted on three channels. In one embodiment, the legacy symbols 312 can be represented, for example, by one or more of the symbols of the first portion 205 of the PPDU preamble as shown and described in connection with FIG. 2.

In one embodiment, the legacy symbols 312 of the PPDU 301 can be taken at the legacy sample (or chip) rate. In one embodiment, the legacy sample (or chip) rate equal to approximately Fc=1.76 GHz, and the can have sample (or chip) duration of approximately Tc=1/Fc=0.57 ns, and where Fc represents the carrier frequency.

In another embodiment, a first sample 316, a second sample 318, and/or a third sample 320, can be taken at a second, higher sampling rate with respect to the sample rate taken for the last symbols 312. For example, of approximately Fb=N_{CB}*1.76 GHz (N_{CB}=2, 3, 4), with a smaller sample duration Tb=Tc/N_{CB}. In one embodiment, the first sample 316, the second sample 318, and/or the third sample 320 can be represented, for example, by any one of the symbols of the second portion 210 of the PPDU preamble as shown and described in connection with FIG. 2.

In one embodiment, the transition interval 314 can be defined between different sample rate definitions used for the different symbol types, that is between the legacy symbols 312, the first sample 316, the second sample 318, and/or the third sample 320. In various embodiments, the disclosure describes defining the time interval duration between the centers of the last sample taken at the legacy rate (for example, equal to approximately Fc=1.76 GHz) and the first sample taken at a second sample rate (for example, of approximately Fb=N_{CB}*1.76 (N_{CB}=2, 3, 4), where N_{CB} is equal to the channel bonding factor). In one embodiment, the second sample rate can be equal to the chip time duration (for example, of approximately Tc=0.57 ns), which can be independent of the channel bonding factor N_{CB}. In one embodiment, the chip time can refer to the duration of a given pulse of binary data of multiple pulses of binary data transmitted over the network.

In one embodiment the time interval 314 duration between the center of the first can be equal to multiple integral of the chip time, Tc.

In another embodiment, the duration of the transition interval can depend on the channel bonding factor and may be equal to approximately Tc/4, approximately Tc/3 and approximately 3*Tc/8 in case of N_{CB}=2, 3, and 4, accordingly.

A formula for the transition interval 314 duration can be written as:

Ttr=(Tc/2)*(1−1/N_{CB}) (eq. 2).

In one embodiment the definition of a signal comprising one or more symbols for transmission during the transition interval 314 may be not defined since the interval may be too short, e.g., below a predetermined threshold in length and/or size. In other embodiment the signal in 314 may be defined as a zero signal (which can be referred to as a “quiet” period). Alternatively or additionally, the definition of the signal comprising one or more symbols for transmission during the transition interval 314 may be defined for use, for example, in accordance with one or more standards. For example, the signal comprising one or more symbols for transmission during the transition interval 314 can include synchronization information, data, metadata, Request to Send (RTS) and/or Clear to Send (CTS) information, and the like.

FIG. 3C show diagram of an example definition of the transition interval for a channel bonding factor of 4 in the case of single stream transmission in accordance with example embodiments of the disclosure.

In one embodiment, FIG. 3C represents a single stream transmission PPDU 303 with a channel bonding factor of 4. In one embodiment, the PPDU 303 can include legacy symbols 322 transmitted on four channels. In one embodiment, the legacy symbols 322 can be represented, for example, by one or more of the symbols of the first portion 205 of the PPDU preamble as shown and described in connection with FIG. 2.

In one embodiment, the legacy symbols 322 of the PPDU 303 can be taken at the legacy sample (or chip) rate. In one embodiment, the legacy sample (or chip) rate equal to approximately Fc=1.76 GHz, and the can have sample (or chip) duration of approximately Tc=1/Fc=0.57 ns, and where Fc represents the carrier frequency.

In another embodiment, a first sample 326, a second sample 328, a third sample 330, and/or a fourth symbol 332 can be taken at a second, higher sampling rate with respect to the sample rate taken for the last symbols 322. For example, of approximately Fb=N_{CB}*1.76 GHz (N_{CB}=2, 3, 4), with a smaller sample duration Tb=Tc/N_{CB}. In one embodiment, the first sample 326, the second sample 328, the third sample 330, and/or the fourth sample 332 can be represented, for example, by any one of the symbols of the second portion 210 of the PPDU preamble as shown and described in connection with FIG. 2.

In one embodiment, the transition interval 324 can be defined between different sample rate definitions used for the different symbol types, that is between the legacy symbols 322, the first sample 326, the second sample 328, the third sample 330, and/or the fourth sample 332. In various embodiments, the disclosure describes defining the time interval duration between the centers of the last sample taken at the legacy rate (for example, equal to approximately Fc=1.76 GHz) and the first sample taken at a second sample rate (for example, of approximately Fb=N_{CB}*1.76 (N_{CB}=2, 3, 4), where N_{CB} is equal to the channel bonding factor). In one embodiment, the second sample rate can be equal to the chip time duration (for example, of approximately Tc=0.57 ns), which can be independent of the channel bonding factor N_{CB}.

In one embodiment the time interval 324 duration between the center of the first can be equal to multiple integral of the chip time, Tc.

In another embodiment, the duration of the transition interval can depend on the channel bonding factor and may be equal to approximately Tc/4, approximately Tc/3 and approximately 3*Tc/8 in case of N_{CB}=2, 3, and 4, accordingly.

A formula for the transition interval 324 duration can be written as:

Ttr=(Tc/2)*(1−1/N_{CB}) (eq. 3).

In one embodiment the definition of a signal comprising one or more symbols for transmission during the transition interval 324 may be not defined since the interval may be too short, e.g., below a predetermined threshold in length and/or size. In other embodiment the signal in 324 may be defined as a zero signal (which can be referred to as a “quiet” period). Alternatively or additionally, the definition of the signal comprising one or more symbols for transmission during the transition interval 324 may be defined for use, for example, in accordance with one or more standards. For example, the signal comprising one or more symbols for transmission during the transition interval 324 can include synchronization information, data, metadata, Request to Send (RTS) and/or Clear to Send (CTS) information, and the like.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

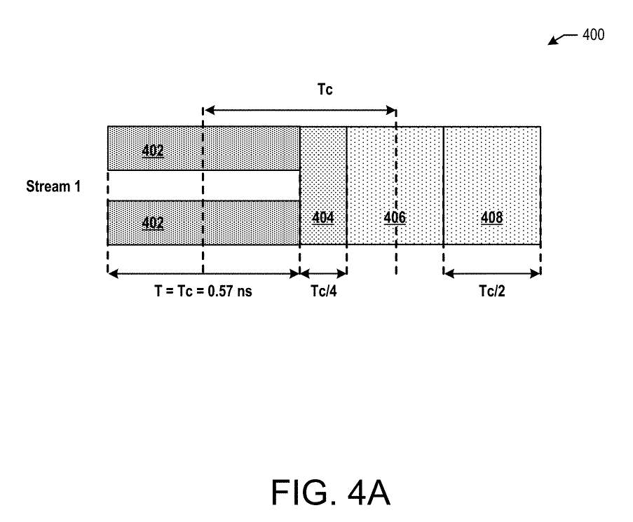

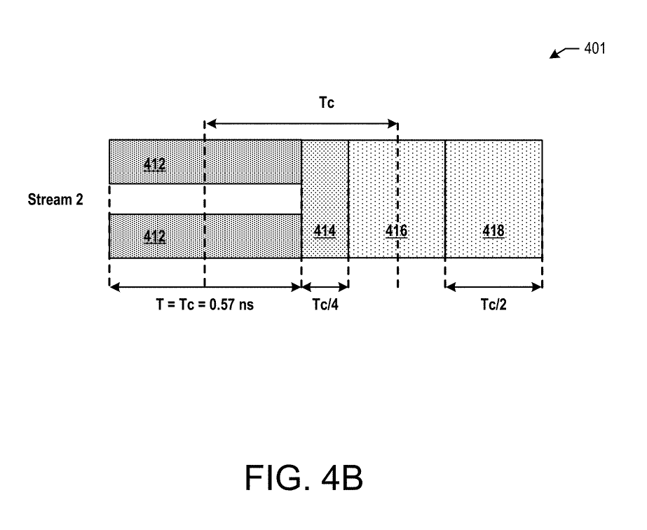

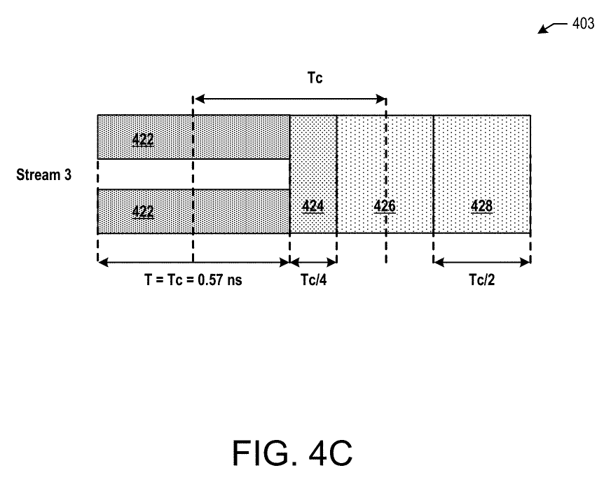

FIG. 4 show diagrams of an example definition of the transition interval for a channel bonding factor of 2 for multiple stream transmission in accordance with example embodiments of the disclosure. In particular, FIG. 4A show diagram of an example definition of the transition interval for a first signal having a channel bonding factor of 2 in the case of multiple stream transmission in accordance with example embodiments of the disclosure. In particular, FIGS. 4B and 4C show example definition of the transition interval for a second stream and a third stream of the signal having a channel bonding factor of 2 in the case of multiple stream transmission in accordance with example embodiments of the disclosure.

In one embodiment, FIG. 4A represents a first stream of a multiple stream transmission PPDU 400 with a channel bonding factor of 2. In one embodiment, the PPDU 400 can include legacy symbols 402 transmitted on two channels. In one embodiment, the legacy symbols 402 can be represented, for example, by one or more of the symbols of the first portion 205 of the PPDU preamble as shown and described in connection with FIG. 2.

In one embodiment, the legacy symbols 402 of the PPDU 400 can be taken at the legacy sample (or chip) rate. In one embodiment, the legacy sample (or chip) rate equal to approximately Fc=1.76 GHz, and the can have sample (or chip) duration of approximately Tc=1/Fc=0.57 ns, and where Fc represents the carrier frequency.

In another embodiment, a first sample 406 and/or a second sample 408 can be taken at a second, higher sampling rate with respect to the sample rate taken for the last symbols 402. For example, of approximately Fb=N_{CB}*1.76 GHz (N_{CB}=2, 3, 4), with a smaller sample duration Tb=Tc/N_{CB}. In one embodiment, the first sample 406 and/or the second sample 408 can be represented, for example, by any one of the symbols of the second portion 210 of the PPDU preamble as shown and described in connection with FIG. 2.

In one embodiment, the transition interval 404 can be defined between different sample rate definitions used for the different symbol types, that is between the legacy symbols 402 and the first sample 406 and/or the second sample 408. In various embodiments, the disclosure describes defining the time interval duration between the centers of the last sample taken at the legacy rate (for example, equal to approximately Fc=1.76 GHz) and the first sample taken at a second sample rate (for example, of approximately Fb=N_{CB}*1.76 (N_{CB}=2, 3, 4), where N_{CB} is equal to the channel bonding factor). In one embodiment, the second sample rate can be equal to the chip time duration (for example, of approximately Tc=0.57 ns), which can be independent of the channel bonding factor N_{CB}.

In one embodiment the time interval 404 duration between the center of the first can be equal to multiple integral of the chip time, Tc.

In another embodiment, the duration of the transition interval can depend on the channel bonding factor and may be equal to approximately Tc/4, approximately Tc/3 and approximately 3*Tc/8 in case of N_{CB}=2, 3, and 4, accordingly.

A formula for the transition interval 404 duration can be written as:

Ttr=(Tc/2)*(1−1/N_{CB}) (eq. 4).

In one embodiment the definition of a signal comprising one or more symbols for transmission during the transition interval 404 may be not defined since the interval may be too short, e.g., below a predetermined threshold in length and/or size. In other embodiment the signal in 404 may be defined as a zero signal (which can be referred to as a “quiet” period). Alternatively or additionally, the definition of the signal comprising one or more symbols for transmission during the transition interval 404 may be defined for use, for example, in accordance with one or more standards. For example, the signal comprising one or more symbols for transmission during the transition interval 404 can include synchronization information, data, metadata, Request to Send (RTS) and/or Clear to Send (CTS) information, and the like.

Similarly, FIG. 4B show diagram of an example definition of the transition interval for a second signal having a channel bonding factor of 2 in the case of multiple stream transmission in accordance with example embodiments of the disclosure. In one embodiment, FIG. 4B represents a second stream of a multiple stream transmission PPDU 401 with a channel bonding factor of 2. In one embodiment, the PPDU 401 can include legacy symbols 412 transmitted on two channels. In one embodiment, the legacy symbols 412 can be represented, for example, by one or more of the symbols of the first portion 205 of the PPDU preamble as shown and described in connection with FIG. 2.

In one embodiment, the legacy symbols 412 of the PPDU 401 can be taken at the legacy sample (or chip) rate. In one embodiment, the legacy sample (or chip) rate equal to approximately Fc=1.76 GHz, and the can have sample (or chip) duration of approximately Tc=1/Fc=0.57 ns, and where Fc represents the carrier frequency.

In another embodiment, a first sample 416 and/or a second sample 418 can be taken at a second, higher sampling rate with respect to the sample rate taken for the last symbols 412. For example, of approximately Fb=N_{CB}*1.76 GHz (N_{CB}=2, 3, 4), with a smaller sample duration Tb=Tc/N_{CB}. In one embodiment, the first sample 416 and/or the second sample 418 can be represented, for example, by any one of the symbols of the second portion 210 of the PPDU preamble as shown and described in connection with FIG. 2.

In one embodiment, the transition interval 414 can be defined between different sample rate definitions used for the different symbol types, that is between the legacy symbols 412 and the first sample 416 and/or the second sample 418. In various embodiments, the disclosure describes defining the time interval duration between the centers of the last sample taken at the legacy rate (for example, equal to approximately Fc=1.76 GHz) and the first sample taken at a second sample rate (for example, of approximately Fb=N_{CB}*1.76 (N_{CB}=2, 3, 4), where N_{CB} is equal to the channel bonding factor). In one embodiment, the second sample rate can be equal to the chip time duration (for example, of approximately Tc=0.57 ns), which can be independent of the channel bonding factor N_{CB}.

In one embodiment the time interval 414 duration between the center of the first can be equal to multiple integral of the chip time, Tc.

In another embodiment, the duration of the transition interval can depend on the channel bonding factor and may be equal to approximately Tc/4, approximately Tc/3 and approximately 3*Tc/8 in case of N_{CB}=2, 3, and 4, accordingly.

A formula for the transition interval 414 duration can be written as:

Ttr=(Tc/2)*(1−1/N_{CB}) (eq. 5).

In one embodiment the definition of a signal comprising one or more symbols for transmission during the transition interval 414 may be not defined since the interval may be too short, e.g., below a predetermined threshold in length and/or size. In other embodiment the signal in 414 may be defined as a zero signal (which can be referred to as a “quiet” period). Alternatively or additionally, the definition of the signal comprising one or more symbols for transmission during the transition interval 414 may be defined for use, for example, in accordance with one or more standards. For example, the signal comprising one or more symbols for transmission during the transition interval 414 can include synchronization information, data, metadata, Request to Send (RTS) and/or Clear to Send (CTS) information, and the like.

Similarly, FIG. 4C show diagram of an example definition of the transition interval for a third signal having a channel bonding factor of 2 in the case of multiple stream transmission in accordance with example embodiments of the disclosure. In one embodiment, FIG. 4C represents a third stream of a multiple stream transmission PPDU 403 with a channel bonding factor of 2. In one embodiment, the PPDU 403 can include legacy symbols 422 transmitted on two channels. In one embodiment, the legacy symbols 422 can be represented, for example, by one or more of the symbols of the first portion 205 of the PPDU preamble as shown and described in connection with FIG. 2.

In one embodiment, the legacy symbols 422 of the PPDU 403 can be taken at the legacy sample (or chip) rate. In one embodiment, the legacy sample (or chip) rate equal to approximately Fc=1.76 GHz, and the can have sample (or chip) duration of approximately Tc=1/Fc=0.57 ns, and where Fc represents the carrier frequency.

In another embodiment, a first sample 426 and/or a second sample 428 can be taken at a second, higher sampling rate with respect to the sample rate taken for the last symbols 422. For example, of approximately Fb=N_{CB}*1.76 GHz (N_{CB}=2, 3, 4), with a smaller sample duration Tb=Tc/N_{CB}. In one embodiment, the first sample 426 and/or the second sample 428 can be represented, for example, by any one of the symbols of the second portion 210 of the PPDU preamble as shown and described in connection with FIG. 2.

In one embodiment, the transition interval 424 can be defined between different sample rate definitions used for the different symbol types, that is between the legacy symbols 422 and the first sample 426 and/or the second sample 428. In various embodiments, the disclosure describes defining the time interval duration between the centers of the last sample taken at the legacy rate (for example, equal to approximately Fc=1.76 GHz) and the first sample taken at a second sample rate (for example, of approximately Fb=N_{CB}*1.76 (N_{CB}=2, 3, 4), where N_{CB} is equal to the channel bonding factor). In one embodiment, the second sample rate can be equal to the chip time duration (for example, of approximately Tc=0.57 ns), which can be independent of the channel bonding factor N_{CB}.

In one embodiment the time interval 424 duration between the center of the first can be equal to multiple integral of the chip time, Tc.

In another embodiment, the duration of the transition interval can depend on the channel bonding factor and may be equal to approximately Tc/4, approximately Tc/3 and approximately 3*Tc/8 in case of N_{CB}=2, 3, and 4, accordingly.

A formula for the transition interval 424 duration can be written as:

Ttr=(Tc/2)*(1−1/N_{CB}) (eq. 6).

In one embodiment the definition of a signal comprising one or more symbols for transmission during the transition interval 424 may be not defined since the interval may be too short, e.g., below a predetermined threshold in length and/or size. In other embodiment the signal in 424 may be defined as a zero signal (which can be referred to as a “quiet” period). Alternatively or additionally, the definition of the signal comprising one or more symbols for transmission during the transition interval 424 may be defined for use, for example, in accordance with one or more standards. For example, the signal comprising one or more symbols for transmission during the transition interval 424 can include synchronization information, data, metadata, Request to Send (RTS) and/or Clear to Send (CTS) information, and the like.

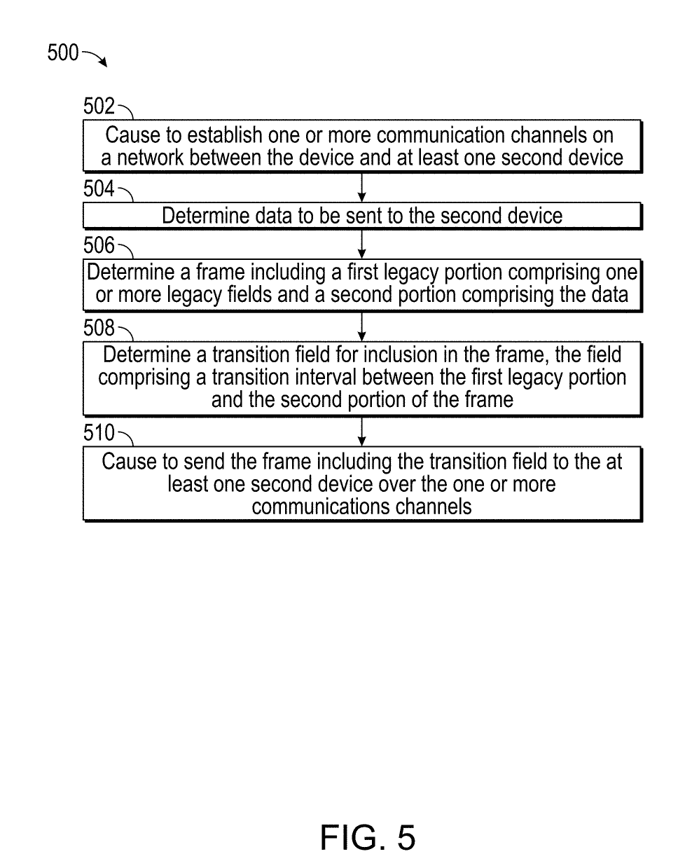

FIG. 5 show diagrams of an example flow chart 500 in accordance with one or more example embodiments of the disclosure. In one embodiment, the flow chart can be used in connection with a transmitting device (for example, an Access Point, AP) on a wireless network.

In block 502, a device (for example, the user device(s) 120 and/or the AP 102 of FIG. 1) can cause to establish one or more communication channels on a network between the device and at least one second device. The establishment of the communications channels may first involve a determination of data by the device to send to one or more devices of the plurality of devices. This determination of the data to send may be made, for example, based on a user input to the device, a predetermined schedule of data transmissions on the network, changes in network conditions, and the like. The establishment of the communications channels may further involve the transmission of one or more data packets (for example, one or more Request to Send, RTS) to notify the one or more devices of the plurality of devices to establish the communications channel. In one embodiment, the establishment of the communications channels may be performed in accordance with one or more wireless and/or network standards.

In block 504, the device can determine data to be sent to the second device. In one embodiment, the data may include instructions to the second device, and/or may include, but not be limited to, content (for example, text, audio, and/or video content). In one embodiment, the data to send may be made, for example, based on a user input to the device, a predetermined schedule of data transmissions on the network, changes in network conditions, and the like.

In block 506 the device can determine a frame including a first legacy portion comprising one or more legacy fields and a second portion comprising the data. In one embodiment, the legacy portion of the frame can be transmitted using a legacy sample (or chip) rate. In one embodiment, the non-legacy portion of the frame can be transmitted using a second, different sample (or chip) rate. In one embodiment, a transition interval field may be defined between the legacy and the non-legacy portions of the frame, the transition interval field having a predetermined time duration. In one embodiment, the transition interval field can be defined and/or used in connection with one or more standards (for example, a IEEE 802.11ay standard). In one embodiment, the various embodiments disclosed herein can be used to facilitate hardware implementation, increase vendor-agnostic compatibility, and allow for accurate, vendor agnostic time-of-flight (ToF) measurements.

In various embodiments, the legacy portion of the frame can include a legacy preamble, a legacy header, a EDMG-Header-A containing single user (SU) multiple-input and multiple-output (MIMO) parameters. In another embodiment, the non-legacy portion of the frame can include an EDMG short training field (EDMG-STF), an EDMG channel estimation field (EDMG-CEF), an EDMG-Header-B containing MU-MIMO parameters, a payload data portion, an optional automatic gain control (AGC), and one or more beamforming training units appended at the end of the frame.

In one embodiment, one or more legacy symbols of the legacy portion of the frame can be taken at the legacy sample (or chip) rate. In one embodiment, the legacy sample (or chip) rate equal to approximately Fc=1.76 GHz, and the can have sample (or chip) duration of approximately Tc=1/Fc=0.57 ns, and where Fc represents the carrier frequency.

In block 508, the device can determine a transition field for inclusion in the frame, the field comprising a transition interval between the first legacy portion and the second portion of the frame. In one embodiment, a transition field may be defined between the legacy and the non-legacy portions of the frame, the transition field having a predetermined time duration, that is the transition interval. In one embodiment, the transition field can be defined and/or used in connection with one or more standards (for example, a IEEE 802.11ay standard). The various embodiments disclosed herein can be used to facilitate hardware implementation, increase vendor-agnostic compatibility, and allow for accurate, vendor agnostic time-of-flight (ToF) measurements.

In various embodiments, the transition interval can occur between the signal taken at the legacy sample (or chip) rate equal to approximately Fc=1.76 GHz and a sample rate equal to approximately Fb=N_{CB}*1.76 GHz (N_{CB}=2, 3, 4) that may be required for channel bonding transmission.

In one embodiment, the transition interval can be defined between different sample rate definitions used for the different symbol types, that is between the legacy symbols of the legacy portion of the frame and the non-legacy symbols of the non-legacy portion of the frame. In various embodiments, the disclosure describes defining the time interval duration between the centers of the last sample taken at the legacy rate (for example, equal to approximately Fc=1.76 GHz) and the first sample taken at a second sample rate (for example, of approximately Fb=N_{CB}*1.76 (N_{CB}=2, 3, 4), where N_{CB} is equal to the channel bonding factor). In one embodiment, the second sample rate can be equal to the chip time duration (for example, of approximately Tc=0.57 ns), which can be independent of the channel bonding factor N_{CB}.

In another embodiment, the duration of the transition interval can depend on the channel bonding factor and may be equal to approximately Tc/4, approximately Tc/3 and approximately 3*Tc/8 in case of N_{CB}=2, 3, and 4, accordingly.

A formula for the transition interval 304 duration can be written as:

Ttr=(Tc/2)*(1−1/N_{CB}) (eq. 7).

In one embodiment the definition of a signal comprising one or more symbols for transmission during the transition interval may be not defined since the interval may be too short, e.g., below a predetermined threshold in length and/or size. In other embodiment the signal in may be defined as a zero signal (which can be referred to as a “quiet” period). Alternatively or additionally, the definition of the signal comprising one or more symbols for transmission during the transition interval may be defined for use, for example, in accordance with one or more standards. For example, the signal comprising one or more symbols for transmission during the transition interval can include synchronization information, data, metadata, Request to Send (RTS) and/or Clear to Send (CTS) information, and the like.

In block 510 the device can cause to send the frame including the transition field to the at least one second device over the one or more communications channels. In one embodiment, the frame including the transition field may be sent at a predetermined time based at least in part on a predetermined schedule of communication between the devices of the network. In another embodiment, first frame including the transition field may be first sent by the device, a period of time may elapse, and the device may repeat some or all of the procedures described in connection with block 508, and resend second frame including the transition field. In one embodiment during, or after the transmission of the frame including the transition field, the device may receive information from the receiving device, indicative of a change to be performed by the transmitting device in sending data. For example, the information may indicate to change the number of streams of the communications channels, to increase and/or decrease the amount of data transmitted on one or more channels of the communications channels, to retransmit one or more packets of data, to send one or more packets of data at a predetermined time, and the like.

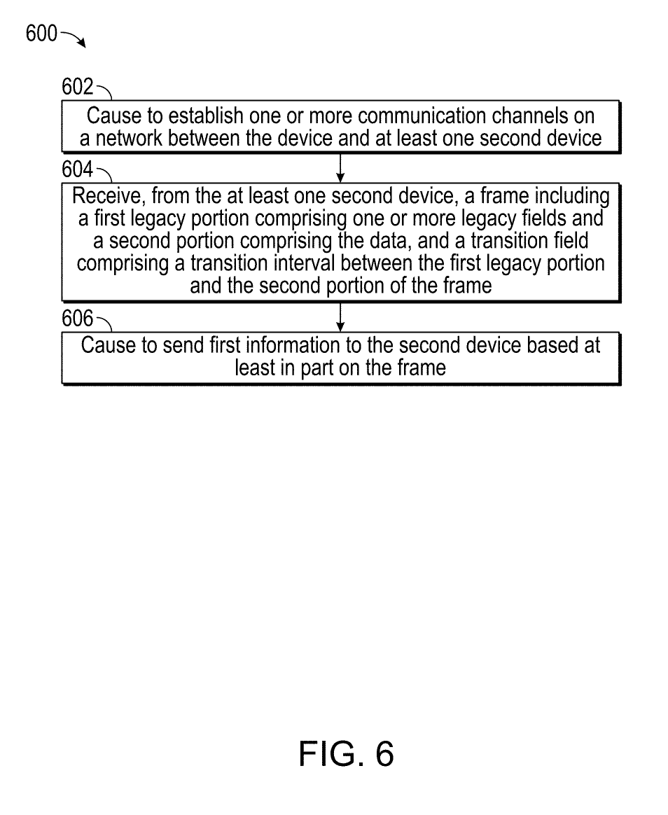

FIG. 6 show diagrams of an example flow chart 600 in accordance with one or more example embodiments of the disclosure. In one embodiment, the flow chart can be used in connection with a receiving device on a wireless network.

In block 602, a device can cause to establish (for example, the user device(s) 120 and/or the AP 102 of FIG. 1) one or more communication channels on a network between the device and at least one second device.

The establishment of the communications channels may first involve a determination of data by the device to send to the second device. This determination of the data to send may be made, for example, based on a user input to the device, a predetermined schedule of data transmissions on the network, changes in network conditions, and the like. The establishment of the communications channels may further involve the transmission of one or more data packets (for example, one or more Request to Send (RTS)) to notify the second device to establish the communications channel. In one embodiment, the establishment of the communications channels may be performed in accordance with one or more wireless and/or network standards.

In block 604, the device can receive, from the at least one second device, a frame including a first legacy portion comprising one or more legacy fields and a second portion comprising the data, and a transition field comprising a transition interval between the first legacy portion and the second portion of the frame.

In one embodiment, the legacy portion of the frame can be received using a legacy sample (or chip) rate. In one embodiment, the non-legacy portion of the frame can be received using a second, different sample (or chip) rate. In one embodiment, a transition interval field may be defined between the legacy and the non-legacy portions of the frame, the transition interval field having a predetermined time duration. In one embodiment, the transition interval field can be defined and/or used in connection with one or more standards (for example, a IEEE 802.11ay standard). In one embodiment, the various embodiments disclosed herein can be used to facilitate hardware implementation, increase vendor-agnostic compatibility, and allow for accurate, vendor agnostic time-of-flight (ToF) measurements.

In various embodiments, the legacy portion of the frame can include a legacy preamble, a legacy header, a EDMG-Header-A containing single user (SU) multiple-input and multiple-output (MIMO) parameters. In another embodiment, the non-legacy portion of the frame can include an EDMG short training field (EDMG-STF), an EDMG channel estimation field (EDMG-CEF), an EDMG-Header-B containing MU-MIMO parameters, a payload data portion, an optional automatic gain control (AGC), and one or more beamforming training units appended at the end of the frame.

In one embodiment, one or more legacy symbols of the legacy portion of the frame can be taken at the legacy sample (or chip) rate. In one embodiment, the legacy sample (or chip) rate equal to approximately Fc=1.76 GHz, and the can have sample (or chip) duration of approximately Tc=1/Fc=0.57 ns, and where Fc represents the carrier frequency.

In one embodiment, the transition field may be defined between the legacy and the non-legacy portions of the frame, the transition field having a predetermined time duration, that is the transition interval. In one embodiment, the transition field can be defined and/or used in connection with one or more standards (for example, a IEEE 802.11ay standard). The various embodiments disclosed herein can be used to facilitate hardware implementation, increase vendor-agnostic compatibility, and allow for accurate, vendor agnostic time-of-flight (ToF) measurements.

In various embodiments, the transition interval can occur between the signal taken at the legacy sample (or chip) rate equal to approximately Fc=1.76 GHz and a sample rate equal to approximately Fb=N_{CB}*1.76 GHz (N_{CB}=2, 3, 4) that may be required for channel bonding transmission.

In one embodiment, the transition interval can be defined between different sample rate definitions used for the different symbol types, that is between the legacy symbols of the legacy portion of the frame and the non-legacy symbols of the non-legacy portion of the frame. In various embodiments, the disclosure describes defining the time interval duration between the centers of the last sample taken at the legacy rate (for example, equal to approximately Fc=1.76 GHz) and the first sample taken at a second sample rate (for example, of approximately Fb=N_{CB}*1.76 (N_{CB}=2, 3, 4), where N_{CB} is equal to the channel bonding factor). In one embodiment, the second sample rate can be equal to the chip time duration (for example, of approximately Tc=0.57 ns), which can be independent of the channel bonding factor N_{CB}.

In another embodiment, the duration of the transition interval can depend on the channel bonding factor and may be equal to approximately Tc/4, approximately Tc/3 and approximately 3*Tc/8 in case of N_{CB}=2, 3, and 4, accordingly.

A formula for the transition interval 304 duration can be written as:

Ttr=(Tc/2)*(1−1/N_{CB}) (eq. 8).

In one embodiment the definition of a signal comprising one or more symbols for transmission during the transition interval may be not defined since the interval may be too short, e.g., below a predetermined threshold in length and/or size. In other embodiment the signal in may be defined as a zero signal (which can be referred to as a “quiet” period). Alternatively or additionally, the definition of the signal comprising one or more symbols for transmission during the transition interval may be defined for use, for example, in accordance with one or more standards. For example, the signal comprising one or more symbols for transmission during the transition interval can include synchronization information, data, metadata, Request to Send (RTS) and/or Clear to Send (CTS) information, and the like.

In block 606 the device can cause to send first information to the second device based at least in part on the frame. In one embodiment during, or after the reception of the frame, the device may determine the first information, the information indicative of a change to be performed by the transmitting device in sending data. For example, the first information may indicate to the second device to change the number of streams of the communications channels, to increase and/or decrease the amount of data transmitted on one or more channels of the communications channels, to retransmit one or more packets of data, to send one or more packets of data at a predetermined time, and the like.

FIG. 7 shows a functional diagram of an exemplary communication station 700 in accordance with some embodiments. In one embodiment, FIG. 7 illustrates a functional block diagram of a communication station that may be suitable for use as an AP 102 (FIG. 1) or communication station user device 120 (FIG. 1) in accordance with some embodiments. The communication station 700 may also be suitable for use as a handheld device, mobile device, cellular telephone, smartphone, tablet, netbook, wireless terminal, laptop computer, wearable computer device, femtocell, High Data Rate (HDR) subscriber station, access point, access terminal, or other personal communication system (PCS) device.

The communication station 700 may include communications circuitry 702 and a transceiver 710 for transmitting and receiving signals to and from other communication stations using one or more antennas 701. The communications circuitry 702 may include circuitry that can operate the physical layer communications and/or medium access control (MAC) communications for controlling access to the wireless medium, and/or any other communications layers for transmitting and receiving signals. The communication station 700 may also include processing circuitry 706 and memory 708 arranged to perform the operations described herein. In some embodiments, the communications circuitry 702 and the processing circuitry 706 may be configured to perform operations detailed in FIGS. 1-6.

The communication station 700 may include communications circuitry 702 and a transceiver 710 for transmitting and receiving signals to and from other communication stations using one or more antennas 701. The transceiver 710 may be a device comprising both a transmitter and a receiver that are combined and share common circuitry (e.g., communication circuitry 702). The communication circuitry 702 may include amplifiers, filters, mixers, analog to digital and/or digital to analog converters. The transceiver 710 may transmit and receive analog or digital signals. The transceiver 710 may allow reception of signals during transmission periods. This mode is known as full-duplex, and may require the transmitter and receiver to operate on different frequencies to minimize interference between the transmitted signal and the received signal. The transceiver 710 may operate in a half-duplex mode, where the transceiver 710 may transmit or receive signals in one direction at a time.

In accordance with some embodiments, the communications circuitry 702 may be arranged to contend for a wireless medium and configure frames or packets for communicating over the wireless medium. The communications circuitry 702 may be arranged to transmit and receive signals. The communications circuitry 702 may also include circuitry for modulation/demodulation, upconversion/downconversion, filtering, amplification, etc. In some embodiments, the processing circuitry 706 of the communication station 700 may include one or more processors. In other embodiments, two or more antennas 701 may be coupled to the communications circuitry 702 arranged for sending and receiving signals. The memory 708 may store information for configuring the processing circuitry 706 to perform operations for configuring and transmitting message frames and performing the various operations described herein. The memory 708 may include any type of memory, including non-transitory memory, for storing information in a form readable by a machine (e.g., a computer). For example, the memory 708 may include a computer-readable storage device may, read-only memory (ROM), random-access memory (RAM), magnetic disk storage media, optical storage media, flash-memory devices and other storage devices and media.

In some embodiments, the communication station 700 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 700 may include one or more antennas 701. The antennas 701 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 700 may include one or more of a keyboard, a display, a non-volatile memory port, multiple antennas, a graphics processor, an application processor, speakers, and other mobile device elements. The display may be an LCD screen including a touch screen.

Although the communication station 700 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 700 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 700 may include one or more processors and may be configured with instructions stored on a computer-readable storage device memory.

FIG. 8 illustrates a block diagram of an example of a machine 800 or system upon which any one or more of the techniques (e.g., methodologies) discussed herein may be performed. In other embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environments. The machine 1000 may be a personal computer (PC), a tablet PC, a set-top box (STB), a personal digital assistant (PDA), a mobile telephone, wearable computer device, a web appliance, a network router, switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 800 may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808. The machine 800 may further include a power management device 832, a graphics display device 810, an alphanumeric input device 812 (e.g., a keyboard), and a user interface (UI) navigation device 814 (e.g., a mouse). In an example, the graphics display device 810, alphanumeric input device 812, and UI navigation device 814 may be a touch screen display. The machine 800 may additionally include a storage device (i.e., drive unit) 816, a signal generation device 818 (e.g., a speaker), a transition interval device 819, a network interface device/transceiver 820 coupled to antenna(s) 830, and one or more sensors 828, such as a global positioning system (GPS) sensor, compass, accelerometer, or other sensor. The machine 800 may include an output controller 834, such as a serial (e.g., universal serial bus (USB), parallel, or other wired or wireless (e.g., infrared (IR), near field communication (NFC), etc.) connection to communicate with or control one or more peripheral devices (e.g., a printer, card reader, etc.)).

The storage device 816 may include a machine readable medium 822 on which is stored one or more sets of data structures or instructions 824 (e.g., software) embodying or utilized by any one or more of the techniques or functions described herein. The instructions 824 may also reside, completely or at least partially, within the main memory 804, within the static memory 806, or within the hardware processor 802 during execution thereof by the machine 800. In an example, one or any combination of the hardware processor 802, the main memory 804, the static memory 806, or the storage device 816 may constitute machine-readable media.

The transition interval device 819 may be configured to cause to establish, by the device, at least one communication channel on a network, between the device and at least one second device; determine, by the device, data to be sent to the second device; determine, by the device, a frame including a first legacy portion, and a second portion including the data; determine, by the device, a transition interval between the first legacy portion and the second portion of a frame; and cause to send, by the device, the frame to the at least one second device. In one embodiment, the frame can include an enhanced directional multi gigabit (EDMG) frame. In another embodiment, the frame comprises one or more a legacy preamble, a legacy header, a EDMG-Header-A comprising single user (SU) multiple-input and multiple-output (MIMO) parameters, an EDMG short training field (EDMG-STF), an EDMG channel estimation field (EDMG-CEF), an EDMG-Header-B comprising MU-MIMO parameters, a data field, an automatic gain control (AGC) field, and one or more beamforming training fields.

It is understood that the above are only a subset of what the transition interval device 819 may be configured to perform and that other functions included throughout this disclosure may also be performed by the transition interval device 819.

While the machine-readable medium 822 is illustrated as a single medium, the term “machine-readable medium” may include a single medium or multiple media (e.g., a centralized or distributed database, and/or associated caches and servers) configured to store the one or more instructions 824.

The term “machine-readable medium” may include any medium that is capable of storing, encoding, or carrying instructions for execution by the machine 800 and that cause the machine 800 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., Electrically Programmable Read-Only Memory (EPROM), or Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 824 may further be transmitted or received over a communications network 826 using a transmission medium via the network interface device/transceiver 820 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), Plain Old Telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 820 may include one or more physical jacks (e.g., Ethernet, coaxial, or phone jacks) or one or more antennas to connect to the communications network 826. In an example, the network interface device/transceiver 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 800 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Example 1 is a device, comprising: at least one memory that stores computer-executable instructions; and at least one processor of the one or more processors configured to access the at least one memory, wherein the at least one processor of the one or more processors is configured to execute the computer-executable instructions to: cause to establish one or more communication channels between the device and a second device; determine data to be sent to the second device; determine a frame including a first legacy portion comprising one or more legacy fields and a second portion comprising the data; determine a transition field for inclusion in the frame, the transition field comprising a transition interval between the first legacy portion and the second portion of the frame; and cause to send the frame including the transition field to the second device over the one or more communications channels. In example 2, the device of example 1 can optionally include the first legacy portion of the frame being associated with a directional multi gigabit (DMG) device and the second portion of the frame is associated with an enhanced directional multi gigabit (EDMG) device. In example 3, the device of any one of examples 1-2 can optionally include the first legacy portion of the frame comprising one or more of a legacy preamble field, a legacy header field, or an EDMG-Header-A field comprising single user (SU) multiple-input and multiple-output (MIMO) parameters, and the second portion of the frame comprising one or more of an EDMG short training field (EDMG-STF), an EDMG channel estimation field (EDMG-CEF), an EDMG-Header-B field comprising multi-user (MU) MIMO parameters, a data field, an automatic gain control (AGC) field, or a beamforming training field. In example 4, the device of any one of examples 1-3 can optionally include the first legacy portion of the frame can be transmitted using a legacy sample rate of approximately 1.76 gigahertz. In example 5, the device of any one of examples 1-4 can optionally include the transition interval being an indication of a duration between a midpoint between a first duration of a first data field taken at a legacy sample rate and a second duration of a second data field taken at a second sample rate. In example 6, the device of any one of examples 1-5 can optionally include the transition interval being based on a chip time. In example 7, the device of any one of examples 1-6 can optionally include the transition interval being based at least in part on a channel bonding factor. In example 8, the device of any one of examples 1-7 can optionally include one or more streams being transmitted over the one or more communications channels. In examples 9, the device of any one of examples 1-8 can optionally include a transceiver configured to transmit and receive wireless signals, and an antenna coupled to the transceiver.

Example 10 is a non-transitory computer-readable medium storing computer-executable instructions which, when executed by a processor, cause the processor to perform operations comprising: causing to establish one or more communication channels on a network between a device and a second device; determining data to be sent to the second device; determining a frame including a first legacy portion comprising one or more legacy fields and a second portion comprising the data; determining a transition field for inclusion in the frame, the transition field comprising a transition interval between the first legacy portion and the second portion of the frame; and causing to send the frame including the transition field to the second device over the one or more communications channels. In example 11, the computer-readable medium of example 10 can optionally include the first legacy portion of the frame being associated with a directional multi gigabit (DMG) device and the second portion of the frame being associated with an enhanced directional multi gigabit (EDMG) device. In example 12, the computer-readable medium of any one of examples 10-11 can optionally include the first legacy portion of the frame comprising one or more of a legacy preamble field, a legacy header field, or an EDMG-Header-A field comprising single user (SU) multiple-input and multiple-output (MIMO) parameters, and the second portion of the frame comprising one or more of an EDMG short training field (EDMG-STF), an EDMG channel estimation field (EDMG-CEF), an EDMG-Header-B field comprising multi-user (MU) MIMO parameters, a data field, an automatic gain control (AGC) field, or a beamforming training field. In example 13, the computer-readable medium of any one of examples 10-12 can optionally include the first legacy portion of the frame can be transmitted using a legacy sample rate of approximately 1.76 gigahertz. In example 14, the computer-readable medium of any one of examples 10-13 can optionally include the transition interval is an indication of a duration between a midpoint between a first duration of a first data field taken at a legacy sample rate and a second duration of a second data field taken at a second sample rate. In example 15, the computer-readable medium of any one of examples 10-14 can optionally include the transition interval being based on a chip time. In example 16, the computer-readable medium of any one of examples 10-15 can optionally include the transition interval being based at least in part on a channel bonding factor. In example 17, the computer-readable medium of any one of examples 10-16 can optionally include one or more streams being transmitted over the one or more communications channels.

Example 18 is a method comprising: establishing one or more communication channels on a network between a device and a second device; determining data to be sent to the second device; determining a frame including a first legacy portion comprising one or more legacy fields and a second portion comprising the data; determining a transition field for inclusion in the frame, the transition field comprising a transition interval between the first legacy portion and the second portion of the frame; and sending the frame including the transition field to the second device over the one or more communications channels. In example 19, the method of example 18 can optionally include the first legacy portion of the frame being associated with a directional multi gigabit (DMG) device and the second portion of the frame being associated with an enhanced directional multi gigabit (EDMG) device. In example 20, the method of any one of examples 18-19 can optionally include the transition interval being based at least in part on a channel bonding factor. In example 21, the method of any one of examples 18-20 can optionally include the first legacy portion of the frame comprising one or more of a legacy preamble field, a legacy header field, or an EDMG-Header-A field comprising single user (SU) multiple-input and multiple-output (MIMO) parameters, and the second portion of the frame comprising one or more of an EDMG short training field (EDMG-STF), an EDMG channel estimation field (EDMG-CEF), an EDMG-Header-B field comprising multi-user (MU) MIMO parameters, a data field, an automatic gain control (AGC) field, or a beamforming training field. In example 22, the method of any one of examples 18-21 can optionally include the first legacy portion of the frame can be transmitted using a legacy sample rate of approximately 1.76 gigahertz. In example 23, the method of any one of examples 18-22 can optionally include the transition interval being an indication of a duration between a midpoint between a first duration of a first data field taken at a legacy sample rate and a second duration of a second data field taken at a second sample rate. In example 24, the method of any one of examples 18-23 can optionally include the transition interval being based on a chip time. In example 25, the method of any one of examples 18-24 can optionally include one or more streams being transmitted over the one or more communications channels.

Example 26 is an apparatus comprising: means for establishing one or more communication channels on a network between a device and a second device; means for determining data to be sent to the second device; means for determining a frame including a first legacy portion comprising one or more legacy fields and a second portion comprising the data; means for determining a transition field for inclusion in the frame, the transition field comprising a transition interval between the first legacy portion and the second portion of the frame; and means for sending the frame including the transition field to the second device over the one or more communications channels. In example 27, the apparatus of example 26 can optionally include the first legacy portion of the frame being associated with a directional multi gigabit (DMG) device and the second portion of the frame is associated with an enhanced directional multi gigabit (EDMG) device. In example 28, the apparatus of any one of examples 26-27 can optionally include the transition interval being based at least in part on a channel bonding factor. In example 29, the apparatus of any one of examples 26-28 can optionally include the first legacy portion of the frame comprising one or more of a legacy preamble field, a legacy header field, or an EDMG-Header-A field comprising single user (SU) multiple-input and multiple-output (MIMO) parameters, and the second portion of the frame comprising one or more of an EDMG short training field (EDMG-STF), an EDMG channel estimation field (EDMG-CEF), an EDMG-Header-B field comprising multi-user (MU) MIMO parameters, a data field, an automatic gain control (AGC) field, or a beamforming training field. In example 30, the apparatus of any one of examples 26-29 can optionally include the first legacy portion of the frame can be transmitted using a legacy sample rate of approximately 1.76 gigahertz. In example 31, the apparatus of any one of examples 26-30 can optionally include the transition interval being an indication of a duration between a midpoint between a first duration of a first data field taken at a legacy sample rate and a second duration of a second data field taken at a second sample rate. In example 32, the apparatus of any one of examples 26-31 can optionally include the transition interval being based on a chip time. In example 33, the apparatus of any one of examples 26-32 can optionally include the transition interval being based at least in part on a channel bonding factor.

In one embodiment, the Tc for a channel bonding factor of 2 can have a length of approximately 0.57 ns, a legacy sample of a duration of approximately Tc, a guard interval of a duration of approximately Tc/4, a first sample of a duration of approximately Tc/2, and a second sample of duration approximately Tc/2.

In one embodiment, the Tc for a channel bonding factor of 3 can have a length of approximately 0.57 ns, a legacy sample of a duration of approximately Tc, a guard interval of a duration of approximately Tc/3, a first sample of a duration of approximately Tc/3, a second sample of duration approximately Tc/3, and a third sample of duration approximately Tc/3.

In one embodiment, the Tc for a channel bonding factor of 4 can have a length of approximately 0.57 ns, a legacy sample of a duration of approximately Tc, a guard interval of a duration of approximately 3Tc/8, a first sample of a duration of approximately Tc/4, a second sample of duration approximately Tc/4, a third sample of duration approximately Tc/4, and fourth sample of duration approximately Tc/4.

In one embodiment, the Tc for 1 stream can have a length of approximately 0.57 ns, a legacy sample of a duration of approximately Tc, a guard interval of a duration of approximately Tc/4, a first sample of a duration of approximately Tc/2, and a second sample of duration approximately Tc/2.

In one embodiment, the Tc for 2 streams can have a length of approximately 0.57 ns, a legacy sample of a duration of approximately Tc, a guard interval of a duration of approximately Tc/4, a first sample of a duration of approximately Tc/2, and a second sample of duration approximately Tc/2.

In one embodiment, the Tc for 3 streams can have a length of approximately 0.57 ns, a legacy sample of a duration of approximately Tc, a guard interval of a duration of approximately Tc/4, a first sample of a duration of approximately Tc/2, and a second sample of duration approximately Tc/2.

The word “exemplary” is used herein to mean “serving as an example, instance, or illustration.” Any embodiment described herein as “exemplary” is not necessarily to be construed as preferred or advantageous over other embodiments. The terms “computing device”, “user device”, “communication station”, “station”, “handheld device”, “mobile device”, “wireless device” and “user equipment” (UE) as used herein refers to a wireless communication device such as a cellular telephone, smartphone, tablet, netbook, wireless terminal, laptop computer, a femtocell, High Data Rate (HDR) subscriber station, access point, printer, point of sale device, access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as ‘communicating’, when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

The term “access point” (AP) as used herein may be a fixed station. An access point may also be referred to as an access node, a base station, or some other similar terminology known in the art. An access terminal may also be called a mobile station, user equipment (UE), a wireless communication device, or some other similar terminology known in the art. Embodiments disclosed herein generally pertain to wireless networks. Some embodiments can relate to wireless networks that operate in accordance with one of the IEEE 802.11 standards.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems following one or more wireless communication protocols, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBeeTM, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems, and/or networks.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, can be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, comprising:
at least one memory that stores computer-executable instructions; and
at least one processor of the one or more processors configured to access the at least one memory, wherein the at least one processor of the one or more processors is configured to execute the computer-executable instructions to:
cause to establish one or more communication channels between the device and a second device;
determine data to be sent to the second device;
determine a frame including a first legacy portion comprising one or more legacy fields and a second portion comprising the data;
determine a transition field for inclusion in the frame, the transition field comprising a transition interval between the first legacy portion and the second portion of the frame; and
cause to send the frame including the transition field to the second device over the one or more communications channels.

2. The device of claim 1, wherein the first legacy portion of the frame is associated with a directional multi gigabit (DMG) device and the second portion of the frame is associated with an enhanced directional multi gigabit (EDMG) device.

3. The device of claim 1, wherein the first legacy portion of the frame comprises one or more of a legacy preamble field, a legacy header field, or an EDMG-Header-A field comprising single user (SU) multiple-input and multiple-output (MIMO) parameters, and the second portion of the frame comprises one or more of an EDMG short training field (EDMG-STF), an EDMG channel estimation field (EDMG-CEF), an EDMG-Header-B field comprising multi-user (MU) MIMO parameters, a data field, an automatic gain control (AGC) field, or a beamforming training field.

4. The device of claim 3, wherein the first legacy portion of the frame can be transmitted using a legacy sample rate of approximately 1.76 gigahertz.

5. The device of claim 1, wherein the transition interval is an indication of a duration between a midpoint between a first duration of a first data field taken at a legacy sample rate and a second duration of a second data field taken at a second sample rate.

6. The device of claim 1, wherein the transition interval is based on a chip time.

7. The device of claim 1, wherein the transition interval is based at least in part on a channel bonding factor.

8. The device of claim 1, wherein one or more streams are transmitted over the one or more communications channels.

9. The device of claim 1, further comprising a transceiver configured to transmit and receive wireless signals, and an antenna coupled to the transceiver.

10. A non-transitory computer-readable medium storing computer-executable instructions which, when executed by a processor, cause the processor to perform operations comprising:
causing to establish one or more communication channels on a network between a device and a second device;
determining data to be sent to the second device;
determining a frame including a first legacy portion comprising one or more legacy fields and a second portion comprising the data;
determining a transition field for inclusion in the frame, the transition field comprising a transition interval between the first legacy portion and the second portion of the frame; and
causing to send the frame including the transition field to the second device over the one or more communications channels.

11. The non-transitory computer-readable medium of claim 10, wherein the first legacy portion of the frame is associated with a directional multi gigabit (DMG) device and the second portion of the frame is associated with an enhanced directional multi gigabit (EDMG) device.

12. The non-transitory computer-readable medium of claim 10, wherein the first legacy portion of the frame comprises one or more of a legacy preamble field, a legacy header field, or an EDMG-Header-A field comprising single user (SU) multiple-input and multiple-output (MIMO) parameters, and the second portion of the frame comprises one or more of an EDMG short training field (EDMG-STF), an EDMG channel estimation field (EDMG-CEF), an EDMG-Header-B field comprising multi-user (MU) MIMO parameters, a data field, an automatic gain control (AGC) field, or a beamforming training field.

13. The non-transitory computer-readable medium of claim 12, wherein the first legacy portion of the frame can be transmitted using a legacy sample rate of approximately 1.76 gigahertz.

14. The non-transitory computer-readable medium of claim 10 wherein the transition interval is an indication of a duration between a midpoint between a first duration of a first data field taken at a legacy sample rate and a second duration of a second data field taken at a second sample rate.

15. The non-transitory computer-readable medium of claim 10, wherein the transition interval is based on a chip time.

16. The non-transitory computer-readable medium of claim 10, wherein the transition interval is based at least in part on a channel bonding factor.

17. The non-transitory computer-readable medium of claim 10, wherein one or more streams are transmitted over the one or more communications channels.

18. A method comprising:
establishing one or more communication channels on a network between a device and a second device;
determining data to be sent to the second device;
determining a frame including a first legacy portion comprising one or more legacy fields and a second portion comprising the data;
determining a transition field for inclusion in the frame, the transition field comprising a transition interval between the first legacy portion and the second portion of the frame; and
sending the frame including the transition field to the second device over the one or more communications channels.

19. The method of claim 18, wherein the first legacy portion of the frame is associated with a directional multi gigabit (DMG) device and the second portion of the frame is associated with an enhanced directional multi gigabit (EDMG) device.

20. The method of claim 18, wherein the transition interval is based at least in part on a channel bonding factor.
